(19) United States
(12) Patent Application Publication
(10) Pub. No.: US 2007/0246688 A1
(43) Pub. Date: Oct. 25, 2007

(54) Microstructuring of Mesogens Using Contact Printing

(76) Inventors: Carlos Sanchez, Zaragoza (ES); Cornelis Wilhelmus Maria Bastiaansen, Montfort (NL); Dirk Broer, Geldrop (NL); Frank Verbakel, Helmond (NL)

Correspondence Address: NIXON & VANDERHYE, PC, 901 NORTH GLEBE ROAD, 11TH FLOOR, ARLINGTON, VA, 22203, US

(21) Appl. No.: 11/631,959

(22) PCT Filed: Jul. 11, 2005
(86) PCT No.: PCT/NL05/00495

§ 371 Date: Feb. 22, 2007

Related U.S. Application Data
(60) Provisional application No. 60/587,045, filed on Jul. 13, 2004.

(51) Int. Cl. B42D 15/00; B41M 3/14

(52) U.S. Cl. 252/299.01; 264/109

(57) ABSTRACT

This invention relates to an improved process for the nano- or microstructuring of a substrate by applying a mesogen or a mesogenic mixture on top of the substrate. The improvement is that the mesogen or mesogenic mixture is contact printed unto the target substrate, said substrate having an alignment layer.

The present invention relates to a process for the nano- or microstructuring of a substrate by applying a mesogen or mesogenic mixture on top of the substrate, a nano- or microstructure obtainable with this process, and the use of said structure in liquid crystal displays, plastic electronics, and security systems.

Micro-structuring of liquid crystals (LCs) is of vital importance in Liquid Crystal Display (LCD) technology. Conventional LCDs generally consist of an LC layer sandwiched between two glasses patterned with electrodes and coated with aligning layers. Generally several optical elements as polarizers, optical retarders and color filters are present in an LCD. Some of these elements need to be structured in the micrometer range.

An accepted method for the micro- or nano-structuring of optical elements, switchable liquid crystal droplets, or microstructures made of liquid crystal to be used in LCDs, plastic electronics or security systems, makes use of reactive liquid crystal mesogens and photolithographic techniques. Van der Zande et al. (B. M. I. van der Zande, A. C. Nieuwkerk, M. van Deurzen, C. A. Renders, E. Peeters, S. J. Roosendaal, Technologies towards patterned optical foils, SID 03 Digest, no. 14.2) discloses such a method wherein patterning is achieved by exposing the material through a lithographic mask. Said method consists of two exposure steps, being mask and flood exposure of the photoalignment layer with polarised UV light prior to applying the retardation film, after which the reactive LC monomer is applied on top of the LCD by conventional coating techniques. The micro-structuring can be performed by exposing different regions (pixels) at different temperatures, adjusting in this way the optical properties.

However, these lithographic technologies are rather complex processes. The multitude of steps to be taken and the precision needed results in a rather time and budget consuming process.

It is one of the objectives of the present invention to provide an alternative solution for the microstructuring of liquid crystals that is less complex. This object is achieved by a process wherein the mesogen or mesogenic mixture is contact printed unto the target substrate, said substrate having an alignment layer.

Contact printing involves bringing in contact a stamp, coated with ink from, for instance, an inkpad, with a substrate, and transferring the ink to the substrate. This includes large scale processes such as for example flexography, off-set, screen printing or tampon printing. Different combinations of stamps, inks, substrates and printing conditions can be used in the present process, resulting in monodomain (flawless) structures with different properties and/or applications.

In the following the details of the process ingredients, the process steps, and several applications of the printed substrates will be given.

The Mesogen or Mesogenic Mixture

The term ‘mesogen’ or ‘liquid crystal’ is used to indicate a material or compound comprising one or more (semi-) rigid rod-shaped, banana-shaped, board-shaped or disk-shaped mesogenic groups, i.e. groups with the ability to show liquid crystal phase behavior. Liquid crystal compounds with rod-shaped or board-shaped groups are also known in the art as ‘calamitic’ liquid crystals. Liquid crystal compounds with a disk-shaped group are also known in the art as ‘discotic’ liquid crystals. Hereinafter the terms ‘liquid crystal’ or ‘mesogen’ are used interchangeably, unless specified otherwise.

There are many types of liquid crystal phases known in the art, ranging between the solid and liquid states, all of which can be used in the present invention. For example, in the nematic phase the molecules have orientational order but no positional order. This type of liquid crystal phase is amongst others used for retarders in LCD technology. Chiral nematic, or cholesteric liquid crystals consist of nematic molecules, wherein the molecules twist slightly from one layer to the next, resulting in a helix formation. Using chiral mixtures in the present invention will induce helical structures in the printed areas. In the smectic phase the molecules maintain the general orientational order of nematics, but also tend to align themselves in layers or planes. Smectic liquid crystals can be applied in polarizers. Due to their anisotropic nature liquid crystal molecules are birefringent. For a more detailed description of the different types of liquid crystals and their phases, reference is made to Collings P. J. Patel J. S. (Eds), “Handbook of Liquid Crystals”, Wiley-VCH, Weinheim, 1998.

Furthermore there is a division in thermotropic and lyotropic liquid crystals. Thermotropic liquid crystals have an isotropic phase at elevated temperatures and show their anisotropic liquid crystal phase upon cooling down. Lyotropic liquid crystals show their liquid crystal phase under the influence of a solvent. The compounds or materials comprising mesogenic groups do not necessarily have to be able to exhibit a liquid crystal phase themselves. It is also possible that they show liquid crystal phase behavior only in mixtures with other compounds.

Examples of suitable reactive mesogens are those comprising acrylate, methacrylate, epoxy, oxethane, vinyl-ether, styrene and thiol-ene groups. Suitable examples are for example described in W004/025337 whose contents are herein incorporated by reference regarding reactive mesogens, referred to in W004/025337 as polymerizable mesogenic compounds and polymerizable liquid crystal materials. Also mixtures of reactive mesogens can be used (Merck Reactive Mesogens, Brighter clearer communication, 2004). Also mixtures of reactive and non-reactive mesogens can be used.

Examples of suitable non-reactive mesogens are those available from Merck, for example as described in their product folder Licristal® Liquid Crystal Mixtures for Electro-Optic Displays (May 2002) whose contents are herein incorporated by reference regarding non-reactive mesogens. In Polymer Dispersed LCs (PDLCs) one can for example use halogenated mesogens, such as for example TL205 (Merck, Darmstadt) or cyanobiphenyls, such as for example E7 (Merck, Darmstadt). Also mixtures of non-reactive mesogens can be used.

It is possible to add additives for specific functionalities to the mesogen or mesonenic mixture. For example one can add dyes, dichroic dyes, dichroic fluorescent dyes, etc.

The Substrate

The substrate can be basically any material, varying from glass to paper or polymers. The target substrate has an alignment layer for orienting the mesogen. This alignment layer can be created either by treating the target substrate, or by applying a treated top layer to other types of substrate that can't be treated for alignment themselves (e.g. paper). Treating of the target substrate can induce planar orientation (parallel to the substrate), homeotropic orientation (perpendicular to the substrate), or tilted orientation of the ink to be printed on top of the substrate, generating anisotropic properties in the printed areas. To create an alignment layer, one can use a polymer that is rubbed with for example a soft cloth to induce planar orientation. Polyvinyl alcohol for example is quite suitable for creating a treated top layer on paper because of its solubility in water. Polyimide (PI) is widely used as a substrate in LCD technologies because of its chemical resistance. Besides mechanical rubbing of the substrate one can also create the alignment layer optically, or by using photoalignment, embossing, self-assembled monolayers, etc.

In a preferred embodiment of the present invention the substrate contains an electrode. By including electrodes (or electrical fields) one can obtain switchable structures. These switchable structures can, amongst others, be advantageous for certain security features, or for PDLCs.

In another preferred embodiment of the present invention the alignment layer comprises uniaxial elements with a periodicity of between 2 and 200 nm. Such alignment layers can for example be achieved by rubbing PI or by embossing and can be advantageous for switchable structures.

The Inkpad

The required properties of the inkpad differ depending on the specific contact printing technology employed. The skilled man in the art is aware of the required properties for the inkpad for each of the different contact printing technologies. In a preferred embodiment of the present invention the mesogen or mesogenic mixture is pre-aligned on the inkpad. This can be achieved by using an inkpad with an aligned mesogen. This inkpad can for example be obtained by using a rubbed polymer, as described above, as an inkpad (or as a top layer on an inkpad) and simply coating a layer of liquid crystal on said rubbed polymer inkpad.

The Stamp

The stamp is generally made of a rubber material, as rubber provides for conformal contact with the substrate making it possible to use rigid and/or non-planar substrates. Any type of rubber can be used, provided that it has an affinity with the ink. In a preferred embodiment of the present invention, a soft elastomeric stamp with a raised image area is used. A raised image area on the stamp provides for the opportunity to print certain patterns, whereas without the raised image area, the substrate will become fully covered with the ink. The soft elastomeric material can for example be polydimethyl siloxane (PDMS). In general, one can use any chemically crosslinked rubber, a thermoplastic elastomer, or a thermoplastic vulcanizate.

In a preferred embodiment the mesogen or mesogenic mixture is pre-aligned on the stamp. This can be achieved by a stamp that induces a preferential orientation of the mesogen (this stamp can be obtained by treating it with one or more alignment layers as described above under ‘the substrate’).

The Process

The process of contact printing according to the present invention generally consists of the following steps: inking of the stamp, printing of the target substrate by bringing the stamp in contact with the substrate, and removal of the stamp. This will result in a structured layer of the mesogen, having a typical thickness in the order of hundreds of nanometers, or even microns. As described above, the transferred mesogen can comprise reactive, non-reactive liquid crystal molecules and other extra functionalities.

In case an elastomeric stamp with a raised image area—according to a preferred embodiment of the stamp—is used, this stamp can be inked with a mesogen or mesogenic compound using a thin layer of the mesogenic material as an inkpad. After the stamp is put in contact with the inkpad, it is removed. In this way the mesogen is transferred only to the raised areas of the stamp and the mesogen is only in the form of the image of the stamp on the substrate.

In a preferred embodiment the mesogen or mesogenic mixture is polymerized during or after the printing step. In the case of reactive inks, polymerization can be performed after the transfer of the ink to the target substrate (when the stamp has already been removed), but polymerization can also be done while the stamp is still in contact with the substrate, in order to get a more planar top part of the printed area. After removal of the stamp, the top part of the printed area generally comes into contact with air, as a result of which the LC molecules tend to change their direction. Therefore it is preferred to polymerize (fix) the molecules before removing the stamp in order to prevent this from happening. Polymerization can for example be thermally or light induced. Appropriate initiators, well known to those skilled in the art, need to be added to the reactive mesogens. This fixes the orientation and therefore all the anisotropic properties of the liquid crystal material, resulting in stable polymeric structures. Inhibitors can be added to control the rate of polymerization.

The processing conditions can vary, and transfer of the ink can be done with different forces, times, and temperatures. The whole process can be carried out at room temperature if the properties of the ink allow it. Processing at higher temperatures can facilitate the ink transfer in very viscous inks. Alternatives for facilitating the ink transfer in very viscous inks are mixing them with other inks or using solvents. Furthermore, the inclusion of surfactants or other additives can be helpful in order to get the desired properties of alignment, shape and topology of the printed area and/or adhesion. The skilled man is aware of such ink compositions.

The liquid crystal patterned structures of the present invention can be used as patterned retarders for LCDs or as quarter wave plates and polarizers for Light Emitting Diode (LED) displays. When light passes through a birefringent layer its polarization state changes. By appropriate choice of the birefringence and the thickness it is possible to generate quarter (to change from linear to circular polarization or vice versa) or half waveplates (polarization rotators).

In a similar way it is also possible to pattern color filters either based on absorptive processes with the inclusion of dyes (dichroic, fluorescent, etc.) or non-absorptive processes with the inclusion of chiral dopants (cholesteric filters).

The patterning of non-reactive liquid crystals on substrates with patterned electrodes can also be used in the generation of LCDs by direct printing of the switchable individual pixels (printable displays).

Besides in the field of displays, other applications can also be mentioned. For example the use of the patterned LC structures according to the present invention in the generation of polymeric electronic devices (plastic electronics), since with the present invention one can pattern liquid-crystalline semi-conductors while preserving their alignment and orientation. This latter feature can be very useful in LEDs, Field Effect Transistors (FETs), etc.

The use of these structures in the implementation of Micro-Electro-Mechanical-Systems (MEMSs) or analogous systems responding to stimuli is also possible. More specifically, the printing techniques are extremely useful in MEMSs based on liquid crystalline polymers which respond to humidity, light, PH, electrical or magnetic fields, etc.

The patterned structures of the present invention can also be used in security systems. Security features can have three levels of inspection: (1) inspection with the naked eye, (2) with simple tools, and (3) with more sophisticated tools. With the present invention structures can be made that can be inspected on all of the three levels. For example, first level inspection can be inspection of the patterned structure itself, based on the reflection colour and the change in colour with the viewing angle, provided that cholesterics are included in the mesogen or mesogenic mixture (visible without any tools). Second level inspection can be based on retardation or polarization effects of the mesogen (using simple tools such as for example a polarizer). One can also include dichroic dyes or dichroic fluorescent dyes to generate dichroism. Quite a lot of different tools can be used for the third level of inspection. For example, such a sophisticated third level inspection tool can be a polarization microscope with the help of which the LC texture is easily visible. Additional safety features can be easily included by using for example a photoaligned layer as target substrate inducing additional polarization effects.

Also features for transmissive, reflective, and transflective security systems can be made with the process according to the present invention. In a transmissive system, the security features are printed on a transparent substrate and second level inspection is performed, for instance, with two crossed polarizers. In the case of a transflective or reflective system, the printing is performed on respectively a semi-transparent or fully reflective mirror. Visual inspection can be performed with a single polarizer.

### EXAMPLES AND COMPARATIVE EXPERIMENTS

The Examples (1-6) and comparative experiments B and C make use of the following stamps and inkpads.

Printing stamps

Silicon masters were used which were produced with photolithography. The masters were fluorinated to facilitate stamp removal. A PDMS precursor (Sylgard 184, Dow Corning) and its curing agent were mixed in a 9/1 ratio and evacuated to remove air. The PDMS was applied on top of the master and cured (24 hours at 70° C.). The PDMS stamp was treated with an oxygen plasma to make the stamp more hydrofylic.

Inkpad

A cleaned glass substrate was coated with a layer of ink using spin-coating. Depending on for instance the viscosity of the ink, a solvent was used or not.

In the case of non-liquid crystalline (meth)acrylates as used in comparative exeriment B, ethanol was used as a solvent. In the case of non-reactive liquid crystals as used in comparative experiment C and Example 1, no solvent was used. In the case of reactive liquid crystalline (meth)acrylates (Examples 2-6), p-xylene was used as a solvent.

### Comparative Experiments

### Comparative Experiment A

The reactive mesogen used was RM257 from Merck and it was mixed with 1 wt. % photoinitiator (Irgacure 369, Ciba Geigy) and 0.25 wt. % of an inhibitor (hydroquinone). As a substrate, rubbed polyimide (PI) on glass was used. A thin layer of the reactive mesogen was applied on the rubbed PI by spincoating, using p-xylene as a solvent for the mesogen. A mask (grating with a pitch of 20 micron) was used and after mask alignment a UV-light exposure was performed. Subsequently, the non-reacted mesogen was removed by etching with p-xylene at room temperature. A birefringent line grating was obtained with a relief structure. Inspection with an optical microscope (crossed polarizers) revealed that the grating had a monodomain structure of aligned, polymerized liquid crystal i.e. rotation of the sample between crossed polarizers resulted in dark and bright states.

The structures produced with lithography exhibit the proper alignment and optical characteristics. However, the procedure to produce these structures is laborious, batch-wise and slow. Moreover, etching procedures are required which further complicate the production procedures.

### Comparative Experiment B

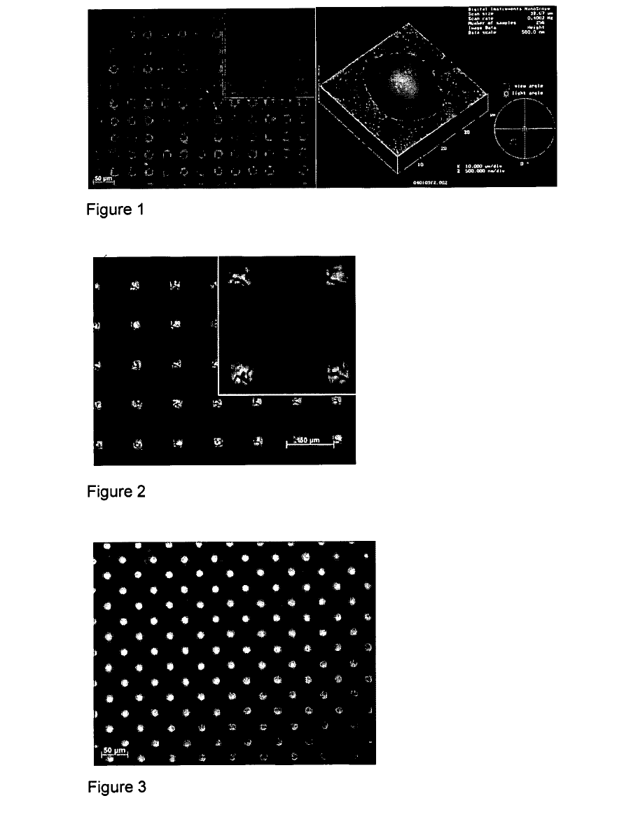

Pentaerythritol tetraacrylate (Aldrich, 40,826-3), pentaerythritol triacrylate (Aldrich, 24,679-4) ortriethylene glycoldiacrylate (Polysciences 1680-21-3) was mixed with a UV-initiator (Irgacure 184, Ciba Geigy). PDMS stamps were produced with a relief structure consisting of arrays of squares (40 micron period, 10×10 micron) and arrays of lines (40 micron period, 10 micron wide). The stamp was inked using an inkpad and printing was performed at room temperature. A variety of substrates (PMMA, glass, PI on glass, rubbed PI on glass) was used. After printing, the microstructures were polymerized with ultra-violet light. A typical example of a print is shown in FIG. 1 (optical microscopy, AFM). These prints with non-liquid crystal inks did not exhibit birefringence and alignment of the material was not observed.

### Comparative Experiment C

A non-reactive liquid crystal (E7, Merck) was used as a printing ink. The printing was performed as in comparative experiment B. A variety of substrates (glass, PI on glass) was used. A typical example of a print is shown in FIG. 2 (optical microscopy, crossed polarizers). The prints exhibited birefringece as is shown in the micrograph above. However, the liquid crystal was not aligned i.e. rotation of the sample between crossed polarizers did not result in dark and bright states.

### EXAMPLES

### Example 1

A non-reactive liquid crystal (E7, Merck) was used as a printing ink. The printing was performed as in comparative experiment B. As a substrate rubbed Pi on glass was used. PI (Optomer ALl 051, JSR Electronics) was spincoated onto the substrates and subsequently baked at 80° C. for 5 minutes and at 180° C. for 90 minutes. A typical example of a print is shown in FIG. 2 (optical microscopy, crossed polarizers). As can be seen in FIG. 3, the prints exhibited birefringence. Also, the prints exhibited a planar, aligned monodomain structure i.e. rotation of the sample between crossed polarizers resulted in dark and bright states.

### Example 2

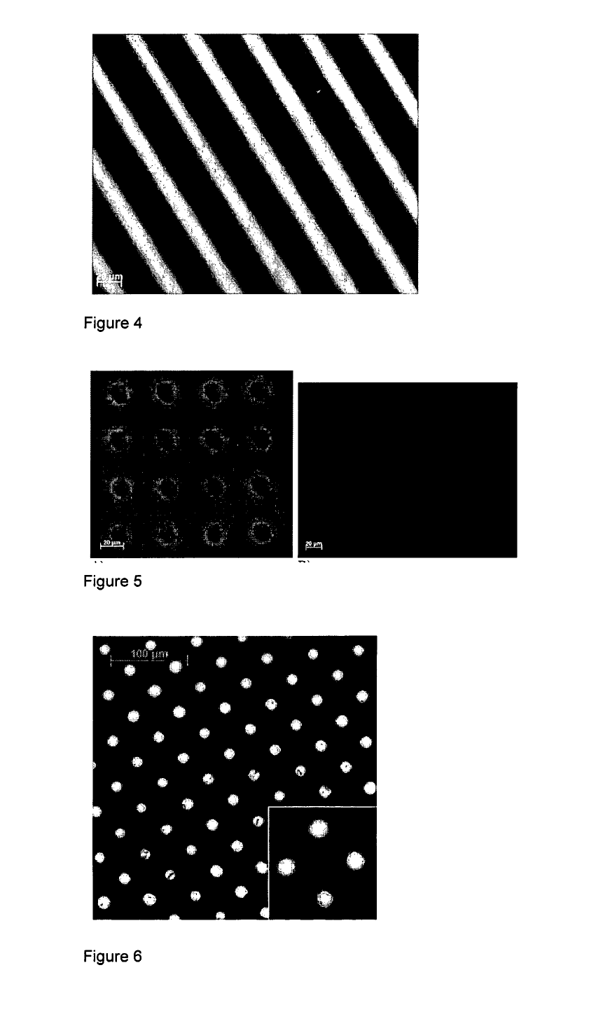

The reactive mesogen used was RM257 from Merck and it was mixed with 1 wt. % photoinitiator (Irgacure 369, Ciba Geigy). The inking of the stamp on the inkpad was performed at 80° C. and printing was also performed at this temperature. As a substrate rubbed PI on glass was used. After printing, the sample was polymerized by exposure to UV-light in a nitrogen atmosphere. A typical example of a print is shown in FIG. 4 (optical microscopy, crossed polarizers). The prints exhibit birefringence as is shown in the micrograph. Also, the prints exhibit a planar aligned monodomain structure i.e. rotation of the sample between crossed polarizers results in dark and bright states.

### Example 3

The reactive mesogen used was RMM77 from Merck and it was mixed with 1 wt. % photoinitiator (Irgacure 369, Ciba Geigy). The inking of the stamp on the inkpad was performed at 80° C. and printing was also performed at this temperature. As a substrate, glass was used (after ozone treatment) as well as glass coated with a homeotropic PI (Nissan Polyimide Varnish, 7511 L). After printing, the sample was polymerized by exposure to UV-light in a nitrogen atmosphere. A typical example of a print is shown in FIG. 5 (optical microscopy, crossed polarizers). The prints were invisible in the optical microscope between crossed polarizers (right photograph of FIG. 5). The phase contrast image illustrated that a print was generated (left photograph of FIG. 5). Also, the print became visible between crossed polarizers at a glancing angle. This illustrates that the prints had a homeotropic monodomain structure.

### Example 4

A reflective surface was produced by vapour deposition of silver onto a cleaned glass substrate. After that, a rubbed PI layer was coated onto the mirror. The reactive mesogen used was RM257 from Merck and it was mixed with 1 wt. % photoinitiator (Irgacure 369, Ciba Geigy). The inking of the stamp on the inkpad was performed at 80° C. and printing was also performed at this temperature. After printing, the sample was polymerized by exposure to UV-light in a nitrogen atmosphere. A typical example of a print is shown in FIG. 6 (optical microscopy). The prints exhibited birefringence as is shown in the micrograph. Also, the prints exhibited a planar aligned monodomain structure i.e. rotation of the sample in reflection mode with a single polarizer resulted in dark and bright states.

### Example 5

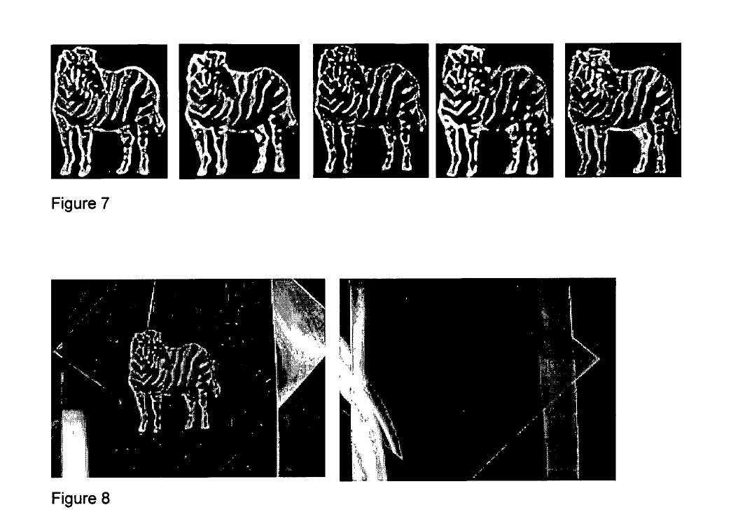

A reactive mesogenic mixture containing RM 257 and RM 82 in a weight ratio 4/1 was used in combination with the chiral dopant LC 257 (all from Merck), and mixed with 1 wt. % photoinitiator (Irgacure 369, Ciba Geigy). Four different mixtures were produced containing resp. 5.8, 5.2, 4.7 and 4.4 wt. % dopant to generate different (reflection) colours. The inking of the stamp on the inkpad was performed at 80° C. and printing was also performed at this temperature. As a substrate, glass coated with a rubbed PI was used. After printing, the sample was polymerized by exposure to UV-light in a nitrogen atmosphere. Typical examples of prints are shown in FIG. 7. The prints exhibited bright (blue, green or red) colours dependent of the amount of chiral dopant used in the mixture. The prints also exhibited a colour shift upon inspection at a glancing angle. Moreover, the prints exhibited circular dichroism as is shown in FIG. 8.

### Example 6

The reactive mesogen used was RM257 from Merck and it was mixed with 1 wt. % photoinitiator (Irgacure 369, Ciba Geigy). Also, 1 wt. % of a fluorescent dye (Coumarin 30) was added to the mixture. The inking of the stamp on the inkpad was performed at 80° C. and printing was also performed at this temperature. As a substrate rubbed PI on glass was used. After printing, the sample was polymerized by exposure to UV-light in a nitrogen atmosphere. The prints had a planar aligned and monodomain structure. The prints also exhibited linear dichroism both in absorption and emission (fluorescence).

1. Process for the nano- or microstructuring of a substrate by applying a mesogen or mesogenic mixture on top of the substrate, wherein the mesogen or mesogenic mixture is contact printed unto the target substrate using a stamp with a raised image area, said substrate having an alignment layer.

2. Process according to claim 1, wherein the mesogen or mesogenic mixture is contact printed by using a soft elastomeric stamp with a raised image area.

3. Process according to claim 1, wherein different mesogens or mesogenic mixtures are printed next to or on top of each other.

4. Process according to claim 1, wherein the mesogen or mesogenic mixture comprises a liquid crystal, a liquid crystal monomer, mixtures thereof, all optionally in the presence of a non-liquid crystal monomer.

5. Process according to claim 1, wherein the mesogen or mesogenic mixture is pre-aligned prior to the printing step.

6. Process according to claim 5, wherein the mesogen or mesogenic mixture is pre-aligned on an inkpad.

7. Process according to claim 5, wherein the mesogen or mesogenic mixture is pre-aligned on the stamp.

8. Process according to claim 2, wherein the soft elastomeric stamp has an aligned raised image area.

9. Process according to claim 1, wherein the mesogen or mesogenic mixture is polymerized during or after the printing step.

10. Process according to claim 1, wherein the substrate contains an electrode.

11. Process according to claim 1, wherein the alignment layer comprises uniaxial elements with a periodicity of between 2 and 200 nm.

12. Nano- or microstructure comprising a substrate and an aligned mesogen or mesogenic mixture, obtainable with a process according to claim 1.

13. Use of the structure according to claim 12 in a liquid crystal display (LCD) or in a component for an LCD.

14. Use of the structure according to claim 12 in (a component for) plastic electronics.

15. Use of the structure according to claim 12 in a security system.
